(19) United States
(12) Patent Application Publication
(10) Pub. No.: US 2021/0205765 A1
(43) Pub. Date: Jul. 8, 2021

(54) ISOPOROUS MEMBRANES INCLUDING CROSSLINKED MULTIBLOCK COPOLYMERS

(71) Applicant: 3M INNOVATIVE PROPERTIES COMPANY, St. Paul, MN (US)

(72) Inventors: Lucas D. McIntosh, Minneapolis, MN (US); Michelle M. Mok, St. Paul, MN (US); John J. Schmidt, Stillwater, MN (US); Carl A. Laskowski, Minneapolis, MN (US); Timothy M. Gillard, St. Paul, MN (US)

(21) Appl. No.: 17/059,545

(22) PCT Filed: Jul. 3, 2019
(86) PCT No.: PCT/IB2019/055696

§ 371 Date: Nov. 30, 2020

Related U.S. Application Data
(60) Provisional application No. 62/697,713, filed on Jul. 13, 2018.

(51) Int. Cl. B01D 71/80; C08J 5/18; C08F 293/00; B01D 71/26; B01D 71/28; B01D 69/02; B01D 67/00

(52) U.S. Cl. CPC B01D 71/80; C08J 5/18; C08F 293/00; B01D 71/26; B01D 71/28; B01D 69/02; B01D 2323/34; C08J 2309/06; B01D 2325/02; B01D 2325/04; B01D 2325/24; B01D 2323/30; B01D 2323/345; B01D 67/009

(57) ABSTRACT

An isoporous membrane includes a multiblock copolymer film. The multiblock copolymer is crosslinked, and the film has a toughness of at least 50 kJ/m³ as a free-standing film when wet, as measured by integrating the area under a stress-strain curve for the film. Methods of forming isoporous membranes are also included.

### BACKGROUND

Porous polymers membranes are used as size-exclusion filters in a variety of industries, including water treatment, food and beverage preparation, and medical/biopharmaceutical. The biopharmaceutical industry places particularly rigorous demands on membranes, including high-temperature stability (e.g., 121° C. autoclave sterilization) and mechanical robustness. Polyethersulfone (PES) has been considered state-of-the-art membrane material because it can meet or exceed the requirements for biopharmaceutical separations.

PES membranes are typically prepared via phase inversion processes (e.g., vapor- or solvent-induced phase separation (VIPS or SIPS)). The morphology of phase inversion membranes can be controlled through a combination of formulation and process conditions. Despite extensive formulation and process optimization, the performance of homopolymer-based membranes such as PES is ultimately limited by a wide distribution of pore sizes and shapes, especially at or near the relevant surface. Block copolymers offer more precise control over pore size and shape distribution, but the pore size is proportional to the molecular weight of the block copolymer. The more desirable small pores are achieved using low molecular weight block copolymers, which suffer from poor mechanical robustness.

It is desirable to have mechanical robust membranes with relatively smaller pore sizes as compared to conventional membranes such as described above.

### SUMMARY

Isoporous membranes are provided that include a multiblock copolymer film, wherein the multiblock copolymer is crosslinked, and the film has a toughness of at least 50 kJ/m³ as a free-standing film when wet, as measured by integrating the area under a stress-strain curve for the film.

Various aspects of the present disclosure relate to methods of making isoporous membranes. The methods include providing an isoporous membrane that includes a non-crosslinked multiblock copolymer film, wherein the film has a toughness of at most 49 kJ/m³ as a free-standing film when wet, as measured by integrating the area under a stress-strain curve for the film; and exposing the isoporous membrane to conditions sufficient for crosslinking at least a portion of the multiblock copolymer.

Surprisingly, crosslinking the membrane using actinic radiation after the membrane is formed enables low molecular weight block copolymers to achieve small pores with good mechanical robustness.

As used herein, the terms “polymer” and “polymeric material” include organic homopolymers, copolymers (e.g., block, graft, random and alternating copolymers, terpolymers, and blends, and modifications thereof). Furthermore, unless otherwise specifically limited, the term “polymer” shall include all possible geometrical configurations of the material. These configurations include cis-, trans-, isotactic, syndiotactic, and atactic symmetries.

As used herein, the term “isoporous membrane” refers to a membrane that has approximately the same pore size within a given plane of the membrane.

As used herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “at least,” “at most,” and “up to” a number (e.g., up to 50) includes the number (e.g., 50).

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

The terms “in the range,” “ranging from,” and “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that at least one member of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in at least one embodiment.

The above summary of the present disclosure is not intended to describe each disclosed embodiment or every implementation of thereof. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a proton nuclear magnetic resonance (¹H-NMR) spectrum of IS4V Sample 2 in CDCl₃.

FIG. 2 is a photograph comparing the result of dissolving a control (no e-beam) membrane to that of a sample subjected to a 40 Mrad (400 kGy) e-beam treatment.

FIG. 3 shows a Fourier transform infrared spectroscopy attenuated total reflectance (FTIR-ATR) spectra of IS4V control (blue) and e-beamed (red) membranes. Absorbance is normalized to the strong styrene band near 750 cm⁻¹. The dashed line indicates the wavenumber of interest, as described in the text. Each trace corresponds to a replicate FTIR run.

FIG. 4 shows differential scanning calorimetry (DSC) traces of IS4V membranes with and without radiation treatment.

FIG. 5 shows the stress-strain response of IS4V membranes with and without e-beam treatment.

FIG. 6 shows the toughness of IS4V membranes with and without e-beam treatment.

FIG. 7 shows the stress-strain response of polyethersulfone (PES) membranes with and without e-beam treatment.

FIG. 8 shows the toughness of PES membranes with and without e-beam treatment.

### DETAILED DESCRIPTION

Block copolymers (BCPs) self-assemble on length scales of 10-100 nanometers and offer precise control over pore size and shape distribution. Numerous methods and processes can be utilized to form isoporous membranes from BCPs. Isoporous membranes are very versatile structures that are utilized for numerous applications in varied fields (e.g., micro/nanofiltration, cell separation and harvesting, controlled drug delivery, optics, gas separation, and chromatography). Isoporous membranes can be prepared in various geometries (e.g., flat sheets and hollow fibers). Although BCP based isoporous membranes offer many advantages, they still suffer from lack of mechanical robustness and solvent resistance. Novel isoporous membranes that include crosslinked multiblock copolymers are provided. The multiblock copolymers can include a variety of types of multiblock copolymers. For example, multiblock copolymers can include diblock copolymers, triblock copolymers, or higher order multiblock copolymers (e.g., pentablock copolymers). The different blocks of a multiblock copolymers can be referred to as, for example, A blocks, B blocks, and C blocks. As such, some illustrative multiblock copolymers include at least an A block and a C block or an A block and a B block.

The A block is generally incompatible with the B and C blocks. The A block can be described as hydrophilic and the B and C blocks can be described a hydrophobic. In various illustrative embodiments, multiblock copolymers can include diblock copolymers having structures of the form A-B, A-C, or any other arrangement; triblock copolymers having structures of the form A-B-C, A-B-A, A-C-B, or any other arrangement; or higher order block copolymers having structures of the form A-B-C-B, A-C-B-C, or any other arrangement, or of the form A-B-C-B-A, A-C-B-C-A, or any other arrangement. Additional different blocks can also be included in multiblock copolymers (e.g., D blocks, E blocks, etc.).

The “B” block of the copolymer comprises polymeric units that form hard, glassy domains upon polymerization. The B block polymeric units have a T_{g} of at least 50° C. (in some embodiments, at least 70° C., or even at least 90° C.).

The B blocks are typically selected from vinyl aromatic monomers (e.g., styrene, α-methylstyrene, para-methylstyrene, 4-methylstyrene, 3-methylstyrene, 4-ethylstyrene, 3,4-dimethylstyrene, 2,4,6-trimethylstyrene, 3-tert-butyl-styrene, 4-tert-butylstyrene, 4-methoxystyrene, 4-trimethylsilylstyrene, 2,6-dichlorostyrene, vinyl naphthalene, 4-chlorostyrene, 3-chlorostyrene, 4-fluorostyrene, 4-bromostyrene, vinyl toluene, ethylstyrene, diethyl styrene, di-n-butylstyrene, isopropylstyrene, other alkylated-styrenes, styrene analogs, and styrene homologs (e.g., vinyl naphthalene, and vinyl anthracene)).

The nature and composition of the monomers which make up the individual C block is not particularly critical so long as the polymerized monomers provide a phase which meets the glass temperature requirement and, thus, can be described as “soft” or “rubbery.” These terms are used interchangeably throughout the specification. It will be understood that “amorphous” blocks contain no or negligible amounts of crystallinity. The amount of crystallinity can be determined, for example, using differential scanning calorimetry (DSC).

In particular embodiments, each block C is independently selected from at least one of polymerized (i) conjugated diene monomers, (ii) a silicon monomer, or (iii) mixtures of monomers wherein segments containing polymerized conjugated diene monomers are optionally hydrogenated. Suitable conjugated dienes include butadiene, isoprene, as well as 1,3-cyclodiene monomers (e.g., 1,3-cyclohexadiene, 1,3-cycloheptadiene and 1,3-cyclooctadiene); in some embodiments, 1,3-cyclohexadiene. When the C blocks of conjugated acyclic dienes (e.g., butadiene) or mixtures thereof are optionally hydrogenated, there are no more than 20 mole percent, 15 mole percent, 10 mole percent, 5 mole percent, 2 mole percent, or 1 mole percent of the carbons in the backbone that form a double bond. C blocks resulting from hydrogenation include poly(ethylene-alt-propylene), poly(butylene), poly(ethylene-co-butylene), and poly(ethylene-co-propylene-co-butylene).

Additionally, the C blocks may be polymer blocks of silicon rubber segments (i.e., blocks of organopolysiloxanes having recurring units of —[Si(R¹⁰)₂—O]—, wherein each R¹⁰ denotes an organic radical (e.g., alkyl, cycloalkyl or aryl)). Such blocks of organopolysiloxanes may be prepared, for example, by anionic polymerization of cyclic siloxanes of the general formula —[Si(R¹⁰)₂—O]ᵣ—, where subscript r is 3 to 7. Cyclic siloxanes, and where subscript r is 3 or 4, and R¹⁰ is methyl. Anionic polymerization of hexamethylcyclotrisiloxane monomer is generally described in: Y. Yamashita et al. (e.g., in Polymer J., 14, 913 (1982); ACS Polymer Preprints, 25 (1), 245 (1984); Makromol. Chem., 185, 9 (1984)).

In some embodiments, the C block comprises a polyacrylate or a polysiloxane. The C blocks can be at least one of polyisoprene, polybutadiene, polybutylene, polyisobutylene, polydimethylsiloxane, polyethylene, poly(ethylene-alt-propylene), poly(ethylene-co-butylene-co-propylene), polybutylene, or poly(ethylene-stat-butylene).

Additionally, each of such blocks C may have a number average molecular weight in a range from 1,000 to 200,000, and may have a glass transition temperature, T_{g}, of ≤25° C. (in some embodiments, ≤0° C.).

The A blocks comprise a copolymer block immiscible in the B and C blocks. The A block can also be described as a hydrophilic block or a hydrogen-bonding block. The immiscible component of the copolymer shows multiple amorphous phases as determined, for example, by the presence of multiple amorphous glass transition temperatures using differential scanning calorimetry or dynamic mechanical analysis. As used herein, “immiscibility” refers to polymer components with limited solubility and non-zero interfacial tension, that is, a blend whose free energy of mixing is greater than zero:

ΔG≅ΔHₘ>0.

Miscibility of polymers is determined by both thermodynamic and kinetic considerations. Common miscibility predictors for non-polar polymers are differences in solubility parameters or Flory-Huggins interaction parameters. For polymers with non-specific interactions (e.g., polyolefins), the Flory-Huggins interaction parameter can be calculated by multiplying the square of the solubility parameter difference with the factor (V/RT), where V is the molar volume of the amorphous phase of the repeated unit, R is the gas constant, and T is the absolute temperature. As a result, the Flory-Huggins interaction parameter between two non-polar polymers is always a positive number.

In some embodiments, the A blocks can be selected from poly(D-lactide), poly(L-lactide), poly(D/L-lactide), polyethyleneoxide, poly(propylene oxide), poly(ethyoxyethylglycidylether), poly(4-vinylpyridine), poly(2-vinylpyridine), poly(hydroxystyrene), poly(acrylamide), poly(acrylic acid), poly(methacrylic acid), poly(methacrylate), poly(methyl methacrylate), poly(dimethylethyl amino ethyl methacrylate), poly(dimethylacrylamide), poly(N-isopropylacrylamide), poly(hydroxyethylmethacrylate), poly-c-caprolactone, and poly(propylenecarbonate).

The A blocks derived from ring-opening anionic polymerization of cyclic monomers or dimers selected from oxiranes (epoxides) to produce polyethers, cyclic sulfides to produce polythioethers, lactones and lactides to produce polyesters, cyclic carbonates to produce polycarbonates, lactams to produce polyamides and aziridines to produce polyamines. Polycarbonates may also be prepared by metal-catalyzed polymerization of carbon dioxide with epoxides listed previously (as described in Journal of the American Chemical Society, 2005, p. 10869). The A blocks may have a linear or branched structure.

Useful epoxides include C₂-C₁₀ (in some embodiments, C₂-C₄) alkyl epoxides (e.g., ethylene oxide, propylene oxide, and butylene oxide), as well as C₂-C₁₀ (in some embodiments, C₃-C₆) glycidyl ethers (e.g., methylglycidylether, ethylglycidylether, allylglycidylether, and ethylethoxy-glycidyl ether)). Another useful epoxide is glycidol, which can provide branched A blocks.

Suitable lactones and lactams are those having 3 to 12 carbon atoms in the main ring and are of the general formula:

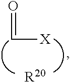

wherein
R²⁰ is an alkylene moiety that may be linear or branched having 1 to 20 carbon atoms (in some embodiments, 1 to 12 carbon atoms) optionally substituted by catenary (in-chain) oxygen atoms, carbonyls or carboxylates; and X is —O— or NR¹—, where R¹ is C₁-C₄ alkyl. It will be appreciated that the cyclic lactones are derived from hydroxy acids including 3-hydroxybutyrate, 4-hydroxybutyrate, 3-hydroxyvalerate, lactic acid, 3-hydroxypropanoate, 4-hydropentanoate, 3-hydroxypentanoate, 3-hydroxyhexanoate, 3-hydroxyheptanoate, 3-hydroxyoctanoate, dioxanone, valerolactone, caprolactone, and glycolic acid. The lactams are derived from the corresponding aminoacids. Dimers of the hydroxy acids (e.g., lactide) may be used.

Useful lactams include 2-pyrrolidone, 2-piperidone, caprolactam, lauryllactam and mixtures thereof.

Useful cyclic carbonates include 5-membered to 7-membered cyclic carbonates. In some embodiments, cyclic components comprise at least one of trimethylene carbonate, neopentyl glycol carbonate, 2,2,4-trimethy I-1,3-pentanediol carbonate, 2,2-dimethyl-1,3-butanediol carbonate, 1,3-butanediol carbonate, 2-methyl-1,3-propanediol carbonate, 2,4-pentanediol carbonate, 2-methyl-butane-1,3-diol carbonate, ethylene carbonate, or propylene carbonate.

Suitable cyclic anhydrides include aliphatic dicarboxylic anhydrides (e.g., succinic anhydride, glutaric anhydride, and maleic anhydride).

Suitable aziridine monomers comprise aziridine and its alkyl-substituted homologues.

Suitable cyclic ethers include 5-membered to 7-membered cyclic ethers. Reference to suitable ring-opening polymerizable monomers may be found in Frisch, Kurt Charles; Rcegaen, Sidney L.; Ring-opening Polymerization: Kinetics and Mechanisms of Polymerization, Dekker Publishing, NY; 1969 and in Su, Wei-Fang, Ring-Opening Polymerization in Principles of Polymer Design and Synthesis; Springer Berlin Heidelberg, pp. 267-299, 2013.

Generally, in multiblock copolymers; the A block can be present in a range from 5 to 30 (in some embodiments, 10 to 25) wt. %, of the total weight of the multiblock copolymer; the combined B and C blocks can be present in a range from 70 to 95 (in some embodiments from 75 to 90) wt. %, of the total weight of the multiblock copolymer; the B block can be present in a range from 30 to 90 (in some embodiments from 60 to 90) wt. %, of the total weight of the multiblock copolymer; and the C block can be present in a range from 10 to 70 (in some embodiments from 10 to 40) wt. %, of the total weight of the multiblock copolymer.

Functional anionic initiators can also be used to provide end-functionalized polymers. These initiators are typically suitable for initiating the recited monomers using techniques known to those skilled in the art. Various functional groups can be incorporated onto the end of a polymer chain using this strategy including: alcohol(s), thiol(s), carboxylic acid, and amine(s). In each of these cases, the initiator must contain protected functional groups that can be removed using post polymerization techniques. Suitable functional initiators are known in the art and are described, for example, in U.S. Pat. No. 6,197,891 (Schwindeman et al.), U.S. Pat. No. 6,160,054 (Periera et al.), U.S. Pat. No. 6,221,991 (Letchford et al.), U.S. Pat. No. 6,184,338 (Schwindeman et al.), and U.S. Pat. No. 5,321,148 (Schwindeman et al.), the disclosures of which are incorporated herein by reference.

These initiators contain tertiary alkyl or trialkylsilyl protecting groups that can be removed by post-polymerization deprotection. Tert-alkyl-protected groups can also be removed by reaction of the polymer with para-toluenesulfonic acid, trifluoroacetic acid, or trimethylsilyliodide to produce alcohol, amino, or thiol functionalities. Additional methods of deprotection of the tert-alkyl protecting groups can be found in T. W. Greene and P. G. M. Wuts, Protective Groups in Organic Synthesis, Second Edition, Wiley, New York, 1991, p. 41. Tert-butyldimethylsilyl protecting groups can be removed by treatment of the polymer with acid (e.g., hydrochloric acid, acetic acid, or para-toluenesulfonic acid). Alternatively, a source of fluoride ions, for instance tetra-n-butylammonium fluoride, potassium fluoride and 18-crown-6, or pyridine-hydrofluoric acid complex, can be employed for deprotection of the tert-butyldimethylsilyl protecting groups. Additional methods of deprotection of the tert-butyldimethylsilyl protecting groups can be found in T. W. Greene and P. G. M. Wuts, Protective Groups in Organic Synthesis, Second Edition, Wiley, New York, 1991, pp. 80-83.

With block copolymer preparation it will be understood that some amount of A, B, C, (co)polymers of any of the blocks, or some combination thereof will also be present in the isolated (co)polymer blend. Generally greater than 50 weight percent of the resulting blend will be the multiblock copolymer, as determined by gel permeation chromatography (GPC) and/or NMR.

Disclosed multiblock copolymers can also be used to prepare isoporous membranes. Isoporous membranes can be prepared using solvent induced phase separation (SIPS) or vapor induced phase separation (VIPS) methods.

Methods that utilize SIPS can include steps of dissolving the multiblock copolymer in a solvent system to form a multiblock copolymer solution or obtaining the multiblock copolymer solution; forming a precursor article from the multiblock copolymer solution; removing at least a portion of the solvent system to form a partially dried precursor article; and contacting the partially dried precursor article with a nonsolvent to form a isoporous membrane including the multiblock copolymer. Various process parameters related to the above steps can be utilized to obtain the desired properties of the membrane.

The step of forming a multiblock copolymer solution includes dissolving the multiblock copolymer solution in a solvent system. The solvent system can be a binary system, or even a ternary system. The solvent system can generally be described as a good solvent for the multiblock copolymer. Illustrative solvent systems can include 2-butanone, dimethylformamide (DMF), dimethylacetamide (DMAc), 1,4-dioxane, diglyme, tetrahydrofuran (THF), N-methylpyrrolidone (NMP), or combinations thereof. The amounts of individual solvents, the identities of the individual solvents, or both can be varied to provide desired properties in membranes. In some embodiments, useful solvent systems include 1,4-dioxane, diglyme, and THF. In some embodiments, useful solvent systems include in a range from 20 to 80 wt. % THF, based on the total weight of the solvent system, with the balance being diglyme and 1,4-dioxane.

The amount of the multiblock copolymer in the multiblock copolymer solution can also be varied to provide desired properties. Generally, useful multiblock copolymer solutions can include at least 5 (in some embodiments, at least 8, or even at least 9) wt. % multiblock copolymer based on the total weight of the multiblock copolymer solution. Generally, useful multiblock copolymer solutions can include not greater than 20 (in some embodiments, not greater than 18, or even not greater than 15) wt. % multiblock copolymer based on the total weight of the multiblock copolymer solution.

In some embodiments, the multiblock copolymer solution does not include photoinitiators. Disclosed methods and membranes can advantageously be crosslinked without the use of photoinitiators.

The step of forming a precursor article can be accomplished using many different processes. Illustrative precursor articles include films, flat sheets, hollow fibers/capillaries, and tubes.

Film type precursor articles can be formed using any known methods of forming a film or layer from a liquid. Illustrative methods include casting the multiblock copolymer solution into a film (e.g., on a substrate of some kind such as a roll or flat substrate or forming a free-standing film, for example, on a temperature-controlled roller) using a notch bar coater, knife coater, for example; spin coating the solution into a film (e.g., on a substrate of some kind) using a spin coater. Film type precursor articles can be described by the thickness thereof, for example. Film type precursors made using a notch bar coater can be formed using a height of the notch bar in a range from 1 mil to 15 mils (25.4 micrometer to 381 micrometers).

Once the precursor article has been formed, the next step is to remove at least a portion of the solvent system to form a partially dried precursor article. The removed portion of the solvent system can be removed by allowing some portion thereof to evaporate (which may remove more of one solvent than the other(s)) under room temperature conditions, elevated temperature conditions, elevated air flow conditions, decreased pressure conditions, or any combination thereof, for example. In some embodiments, the solvent system can be allowed to evaporate for not greater than two minutes (in some embodiments, not greater than 90 seconds, 60 seconds, 45 seconds, 40 seconds, 35 seconds, 30 seconds, 25 seconds, or even not greater than 20 seconds). The removed portion of the solvent system can also be removed by contacting the surface of the precursor article with a liquid in which the removed portion of the solvent system is soluble and then removing that secondary liquid (made up of the liquid and a portion of the solvent system) from the surface of the precursor article. The amount of the solvent system removed, the relative amounts of the solvent(s) in the solvent system removed, or a combination thereof can be varied to provide desired properties.

After a partially dried precursor article has been formed, the next step includes contacting the partially dried precursor article with a nonsolvent. A nonsolvent can also include more than one solvent, as such a nonsolvent refers to a solvent system or a single solvent. A nonsolvent is one in which the multiblock copolymer is substantially insolvent and induces phase separation of the polymer and solvent. The solvent(s) is (are) at least partially soluble and up to fully miscible in the non-solvent(s). Illustrative nonsolvents can include water, alcohols (e.g., methanol, ethanol, and isopropanol), DPM glycol ether (available, for example, under the trade designation “DOWANOL” from the Dow Chemical Company, Midland, Mich.), and pentanes. The choice of the nonsolvent, the concentration of solvent in the nonsolvent bath, additives (e.g., salts in the nonsolvent bath), the time the partially dried precursor is in the nonsolvent, the temperature of the nonsolvent, or combinations thereof can be varied to provide desired properties.

In some embodiments the membrane is free-standing, whereas in alternate embodiments the membrane is disposed on a substrate. Suitable substrates include polymeric membranes, nonwoven substrates, porous ceramic substrates, and porous metal substrates. Optionally, the membrane comprises a hollow fiber membrane. The membrane may have a hollow shape, the fibers themselves may be hollow, or both. In certain embodiments, the hollow fiber membrane can be disposed on a substrate that has a hollow shape. The membrane may be either symmetric or asymmetric, for instance depending on a desired application. In addition, the smallest pores can be located at one surface, the other surface, both surfaces, or at any point through the thickness of the membrane.

Disclosed isoporous membranes can have dry thicknesses, for example, in a range from 0.5 micrometer to 500 micrometers. Illustrative freestanding isoporous membranes can have dry thicknesses, for example, in a range from 25 micrometers to 150 micrometers. Illustrative isoporous membranes cast onto a support can have dry thicknesses, for example, in a range from 0.5 micrometer to 150 micrometers.

Process conditions and specific solution formulations can be selected to provide an isoporous membrane in which the pores of the membrane have an average pore size of at least 1 nanometer (nm) (in some embodiments, at least 5 nm, 10 nm, 20 nm, 30 nm, or even at least 40 nm); and not greater than 500 nm (in some embodiments, not greater than 450 nm, 400 nm, 350 nm, 300 nm, 250 nm, 200 nm, or even not greater than 150 nm). Stated another way, the surface pores (e.g., pores located on at least one membrane surface) may have an average pore size in a range from 1 nm to 500 nm.

In some embodiments, disclosed isoporous membranes have a standard deviation in pore diameter at a surface of the membrane (e.g., surface pore diameter) of not greater than 4 nm from a mean pore diameter at the surface of the membrane when the mean pore diameter at the surface of the membrane ranges from 5 nm to 15 nm, the standard deviation in pore diameter at the surface of the membrane is not greater than 6 nm from the mean pore diameter at the surface of the membrane when the mean pore diameter at the surface of the membrane ranges from greater than 15 nm to 25 nm, and the standard deviation in pore diameter at the surface of the membrane is not greater than 25% of the mean pore diameter at the surface of the membrane when the mean pore diameter at a surface of the membrane ranges from greater than 25 to 50 nm. The mean surface pore diameter is the average diameter of the pores at a surface of the membrane, as opposed to pores within the body of the membrane. Further, an isoporous membrane may have a pore density of at least 1×10¹⁴ pores per square meter.

Disclosed isoporous membranes are at least partially crosslinked, for example, at least partially chemically crosslinked. Disclosed isoporous membranes are at least partially chemically crosslinked by exposing them to actinic radiation. Actinic radiation includes electron beam (“e-beam”) radiation, ultraviolet (UV) radiation, gamma radiation, and any combination thereof. In some embodiments, e-beam radiation can be utilized. In general, exposure of the isoporous membrane to actinic radiation induces chemical crosslinking of the polyisoprene block, which can impact a number of properties.

Suitable e-beam sources are known and are commercially available. In such devices, electron beams (e-beams) are generally produced by applying high voltage to tungsten wire filaments retained between a repeller plate and an extractor grid within a vacuum chamber maintained at about 10⁻⁶ Torr. The filaments are heated at a high current to produce electrons. The electrons are guided and accelerated by a repeller plate and an extractor grid towards a thin window of metal foil. The accelerated electrons, traveling at speeds in excess of 10′ meters/second (m/sec) and possessing about 10 to 300 kiloelectronvolts (keV) pass out of the vacuum chamber through the foil window and penetrate whatever material is positioned immediately beyond the foil window.

The quantity of electrons generated is directly related to the extractor grid voltage. As the extractor grid voltage is increased, the quantities of electrons drawn from the tungsten wire filaments increase. E-beam processing can be extremely precise when under computer control, such that an exact dose of radiation and dose rate of electrons can be directed against materials.

Electron beam generators are commercially available from a variety of sources, including from Energy Sciences, Inc., Wilmington, Mass. under the trade designation “ESI ELECTROCURE EB SYSTEM”, and PCT Engineered Systems, LLC, Davenport, Iowa, under the trade designation “BROADBEAM EB PROCESSOR.” For any given piece of equipment and irradiation sample location, the dosage delivered can be measured in accordance with ASTM E-1275 (1998) entitled “Practice for Use of a Radiochromic Film Dosimetry System.” By altering the extractor grid voltage, beam area coverage and/or distance to the source, various dose rates can be obtained.

A dose profile reaches a maximum, or peak, dose at some distance away from the electron beam source, then decreases with increasing path length. For example, a conventional titanium window having a nominal thickness of about 12 micrometers and a unit path length of 54 g/m² (grams per square meter) absorbs enough energy such that the peak of a depth/dose curve does not move beyond the window/gap regions unless the voltage is increased to above 160 keV. The relative dose of electron beam radiation (calculated values based on Monte Carle code) is characterized as a unit of dose per electron as described in ASTM Standard E2232-02 (2002) (Appendix A5), “Standard Guide for Selection and Use of Mathematical Methods for Calculating Absorbed Dose in Radiation Processing Applications.” The higher voltage typically creates a depth/dose profile that is flat and wide and slowly decreases through the irradiated material.

In some embodiments, the dose of the e-beam source to the isoporous membrane can be at least 2 megarad (Mrad) (20 kGy) (in some embodiments, at least 3 Mrad (30 kGy), 4 Mrad (40 kGy), or even at least 5 Mrad (50 kGy)) and not greater than 50 Mrad (500 kGy) (in some embodiments, not greater than 40 Mrad (400 kGy), 30 Mrad (300 kGy), or even not greater than 20 Mrad (200 kGy)). It will be noted that 1 Mrad is equal to 10 kiloGrays (kGy). In some embodiments, e-beam dosages of 5 Mrad (50 kGy), 10 Mrad (100 kGy), or even 20 Mrad (200 kGy) can be utilized.

The dose of e-beam radiation delivered to an isoporous membrane can be dependent upon both the residence time and the accelerating voltage. In some embodiments, the accelerating voltage of the e-beam source can be at least 100 keV and not greater than 300 keV. In some embodiments, the residence time of the isoporous membrane in the e-beam radiation can be at least 1 second and not greater than 5 seconds. The residence time can be controlled by the web speed. In some embodiments, the web speed can be at least 1 foot per minute (fpm) (0.3 meter/minute) (in some embodiments, at least 5 fpm (1.5 meter/minute) and not greater than 500 fpm (152.4 meter/minute) (in some embodiments, not greater than 25 fpm (7.6 meter/minute)). The delivery of the e-beam radiation can take place in a dry, nitrogen rich environment (e.g., not greater than 100 parts per million (ppm) O₂) or at standard atmospheric conditions (e.g., not greater than 21% O₂).

In certain exemplary embodiments of any of the foregoing, the at least one peak intensity is at a wavelength in a range from 170 (+/−) nm to 400 (+/−5) nm. In some exemplary embodiments, the at least one peak intensity is at a wavelength in a range from 170 (+/−5) nm to about 220 (+/−5) nm. In some exemplary embodiments, the at least one peak intensity is at a wavelength of about 185 (+/−2) nm. In some embodiments, the short wavelength polychromatic ultraviolet light source includes at least one of a low-pressure mercury vapor lamp, a low-pressure mercury amalgam lamp, a pulsed Xenon lamp, or a glow discharge from a polychromatic plasma emission source.

Suitable sources of gamma radiation are well known and include radioisotopes (e.g., cobalt-60 and cesium-137). Generally, suitable gamma ray sources emit gamma rays having energies of at least 400 keV. Typically, suitable gamma ray sources emit gamma rays having energies in the range of 500 keV to 5 MeV. Examples of suitable gamma ray sources include cobalt-60 isotope (which emits photons with energies of about 1.17 and 1.33 MeV in nearly equal proportions) and cesium-137 isotope (which emits photons with energies of about 0.662 MeV). The distance from the source can be fixed or made variable by changing the position of the target or the source. The flux of gamma rays emitted from the source generally decays with the square of the distance from the source and duration of time as governed by the half-life of the isotope. Once a dose rate has been established, the absorbed dose is accumulated over a period of time. During this period of time, the dose rate may vary if the materials are in motion or other absorbing objects pass between the source and sample. For any given piece of equipment and irradiation sample location, the dose delivered can be measured in accordance with ASTM E-1702 (2000) entitled “Practice for Dosimetry in a Gamma Irradiation Facility for Radiation Processing”. Dosimetry may be determined per ASTM E-1275 (1998) entitled “Practice for Use of a Radiochromic Film Dosimetry System” using GEX B3 thin film dosimeters. Thus, in some exemplary embodiments, the reaction mixture is exposed to ionizing radiation for a time sufficient to receive a dose of ionizing radiation up to 100 kGy (in some embodiment, up to 90 kGy, up to 80 kGy, up to 70 kGy, up to 60 kGy, or even up to 50 kGy). In some embodiments, the mixture is exposed to ionizing radiation for a time sufficient to receive a dose of ionizing radiation of at least 5 kGy (in some embodiments, at least 10 kGy, at least 20 kGy, at least 30 kGy, at least 40 kGy, or even at least 50 kGy).

The at least partially crosslinked isoporous membranes, which have been formed via exposure of the isoporous membrane to a source of actinic radiation can have altered properties in comparison to the non-crosslinked isoporous membranes. Examples of such properties can include toughness, crosslink density, and combinations thereof. In some embodiments, toughness can be calculated by integrating a stress-strain curve over the strain range from 0 to 0.1, for example (which can be quantified, for example, as kJ/m³). Advantageously, isoporous membranes according to at least some embodiments of the present disclosure provide good toughness properties. Having a minimum toughness allows the membrane to be handled and used in various applications without becoming damaged. For example, in certain embodiments, the membrane exhibits a toughness of at least 50 kJ/m³ as a free-standing film when dry, as measured by integrating the area under a stress-strain curve for the membrane. A method of measuring the toughness is described further in the Examples section below.

The crosslink density of a membrane can be quantified by determining the gel fraction remaining after dissolution in a solvent. Crosslinking of the membrane via exposure to actinic radiation can render the membrane insoluble in an otherwise good solvent(s). The observation of an insoluble gel fraction is consistent with infrared (IR) spectroscopic data that shows the conversion of double to single bonds. Chemical crosslinking is also related to solvent resistance. Solvents such as ethanol typically swell non-actinic radiation exposed membranes, making them susceptible to fracturing. A chemically-crosslinked membrane tends to resist swelling, thus resisting macroscopic fracturing. The toughness of the membrane may also increase because any given chain is now connected to a network of other chains that have to deform and/or break for the sample to fracture.

Isoporous membranes disclosed herein can be utilized in numerous and varied applications. In some embodiments, porous membranes can be utilized as a filter or part of a filter. Exemplary filters can be configured to be coupled with an element that supports the filter (e.g., a filter support). A filter support can function to maintain the filter in operable communication with a receptacle. Exemplary filter supports can offer support across substantially the entire surface area of the filter or less than the entire surface area of the filter. The combination of the filter, the receptacle and the filter support can be referred to herein as a filter assembly. In an embodiment with a disposable liner and a container that holds the disposable liner, the combination of the filter, the container, the liner and the filter support can be referred to as a filter assembly. Further details regarding filters, filter supports, and filter assemblies, as well as additional articles, can be found in commonly assigned PCT Pat. Pub. No. WO2010/078404 (Kshirsagar et al.), the disclosure of which is incorporated herein by reference.

A receptacle can be configured to be operably coupled with a filter. In an embodiment, the receptacle can contain or can be configured to be coupled with an element that supports a filter. Illustrative receptacles can be found, for example, in U.S. Pat. No. 8,685,746 (Halverson et al.) and 8,569,072 (Halverson et al.), and PCT Pub. Nos. WO2009/067503 (Halverson et al.), WO2007/137257 (Halverson et al.), and WO2008/150779 (Ribeiro et al.), the disclosures of which are incorporated herein by reference.

Also disclosed herein are kits. Illustrative kits can include a device for contacting a fluid sample with a filter containing a disclosed porous membrane, and a receptacle. Kits can include at least one plurality of filters, at least one plurality of receptacles, or both. The device can include a sample container, a filter holder, a filter containing a disclosed porous membrane, and an optional first adaptor. The first adaptor can be configured to interface the filter holder with the receptacle.

Often, a second adaptor can be provided and configured to attach the filter holder to a vacuum source or to a collection container. In some embodiments, the device further includes a rotary pump attached to the filter holder or to the second adaptor. In some embodiments of the kit, the receptacle can optionally contain at least one reagent, although in alternate embodiments, at least one reagent can be added to the receptacle at the time of use of the kit. Typically, the receptacle can be configured to be operationally connected to a detection instrument (e.g., a luminometer). Kits can also include other optional components. In some embodiments, a kit can include components that can be utilized to detect microorganisms. If desired, at least one additive (e.g., lysis reagents, bioluminescence assay reagents, nucleic acid capture reagents (e.g., magnetic beads), microbial growth media, buffers (e.g., to moisten a solid sample), microbial staining reagents, washing buffers (e.g., to wash away unbound material), elution agents (e.g., serum albumin), surfactants (available, for example, under the trade designation “TRITON” X-100,” a nonionic surfactant from Union Carbide Chemicals and Plastics, Houston, Tex.), and mechanical abrasion/elution agents (e.g., glass beads)) can be included in a kit as disclosed herein.

In many embodiments, illustrative kits can further include instructions for using the kit. Such instructions typically include method details including some of those described above. Some illustrative kits can include a filter, which can include or be a disclosed porous membrane and a package for containing the filter. Some illustrative kits can include a filter, which can include or be a disclosed porous membrane, a package for containing the filter, and instructions for using the filter.

### ILLUSTRATIVE EMBODIMENTS

With various aspects of the compositions, articles and methods being described, various illustrative combinations are also described to further illustrate various combinations that are useful in certain applications, some of which are described herein. As used herein, “any one of the X embodiments is included” refers to including any one of the embodiments including the designation X (e.g., any one of the A embodiments refers to embodiments A, A1, A2, A5a, etc., and any one of the A5 embodiments refers to embodiments A5, A5a, A5b, etc.).

In illustrative embodiment A, an isoporous membrane includes a multiblock copolymer film. The multiblock copolymer is crosslinked, and the film has a toughness of at least 50 kJ/m³ as a free-standing film when wet, as measured by integrating the area under a stress-strain curve for the film.

In illustrative embodiment A1, the article of the A embodiment is included, wherein the film has a toughness of at least 70 kJ/m³ as a free-standing film when wet, as measured by integrating the area under a stress-strain curve for the film.

In illustrative embodiment A2, the article of the A embodiment is included, wherein the film has a toughness of at least 80 kJ/m³ as a free-standing film when dry, as measured by integrating the area under a stress-strain curve for the film.

In illustrative embodiment A3, the article of the A embodiment is included, wherein the multiblock copolymer has a gel fraction of at least 2 wt. %.

In illustrative embodiment A4, the article of the A embodiment is included, wherein the multiblock copolymer has a crosslink density of at least 10 wt. %.

In illustrative embodiment A5, the article of the A embodiment is included, wherein the multiblock copolymer has a crosslink density of at least 40 wt. %.

In illustrative embodiment A6, the article of the A embodiment is included, wherein the pores at a surface of the membrane have a size of 1 nm to 500 nm.

In illustrative embodiment A7, the article of the A embodiment is included, wherein a standard deviation in pore diameter at a surface of the membrane is at least 4 nm from a mean pore diameter at the surface of the membrane when the mean surface pore diameter is in a range from 5 nm to 15 nm; the standard deviation in pore diameter at the surface of the membrane is at least 6 nm from the mean pore diameter at the surface of the membrane when the mean pore diameter at the surface of the membrane is in a range from 15 nm to 25 nm; and the standard deviation in pore diameter at the surface of the membrane is not greater than 25% of the mean pore diameter at the surface of the membrane when the mean pore diameter at the surface of the membrane is in a range from 25 nm to 50 nm.

In illustrative embodiment A8, the article of the A embodiment is included, wherein the multiblock copolymer is a diblock copolymer, a triblock copolymer, or a pentablock copolymer, wherein at least one block is immiscible with at least one other block.

In illustrative embodiment A9, the article of the A embodiment is included, wherein the multiblock copolymer includes a rubbery block with a low T_{g}; and a hydrogen-bonding block selected from the group consisting of poly((4-vinyl)pyridine), poly((2-vinyl) pyridine), poly(ethylene oxide), poly(methacrylate), poly(methyl methacrylate), poly(dimethylethyl amino ethyl methacrylate), poly(acrylic acid), and poly(hydroxystyrene), wherein the film has a surface layer having a thickness in a range from 20 nm to 500 nm and a plurality of pores in a range from 5 nm to 100 nm in size and a pore density of at least 1×10¹⁴ pores/m²; and wherein the film has a bulk layer having a thickness in range from 5 micrometers to 500 micrometers, pores having a size in a range from 10 nm to 100 micrometers, and an asymmetric substructure.

In illustrative embodiment A10, the article of the A embodiment is included, wherein the multiblock copolymer film is a graded film.

In illustrative embodiment B, a method of making an isoporous membrane of any of the A embodiments includes providing an isoporous membrane comprising a non-crosslinked multiblock copolymer film, wherein the film has a toughness of at most 49 kJ/m³ as a free-standing film when wet, as measured by integrating the area under a stress-strain curve for the film; and exposing the isoporous membrane to conditions sufficient for crosslinking at least a portion of the multiblock copolymer.

In illustrative embodiment B1, the method of the B embodiment is included, wherein conditions sufficient for crosslinking at least a portion of the multiblock copolymer comprise irradiation by actinic radiation.

In illustrative embodiment B2, the method of the B embodiment is included, wherein conditions sufficient for crosslinking at least a portion of the multiblock copolymer comprise irradiation by ultraviolet (UV) energy.

In illustrative embodiment B3, the method of the B embodiment is included, wherein conditions sufficient for crosslinking at least a portion of the multiblock copolymer further comprise a dosage of UV energy in a range from 15 mJ/cm² to 300 mJ/cm².

In illustrative embodiment B4, the method of the B embodiment is included, wherein conditions sufficient for crosslinking at least a portion of the multiblock copolymer comprise exposure to e-beam radiation.

In illustrative embodiment B5, the method of the B embodiment is included, wherein conditions sufficient for crosslinking at least a portion of the multiblock copolymer further comprise a dosage of e-beam radiation in a range from 0.2 Mrad (2 kGy) to 20 Mrad (200 kGy) and a residence time of the isoporous membrane in the e-beam radiation in a range from 1 second to 5 seconds.

In illustrative embodiment B6, the method of the B embodiment is included, wherein conditions sufficient for crosslinking at least a portion of the multiblock copolymer comprise irradiation by gamma radiation.

In illustrative embodiment B7, the method of the B embodiment is included, wherein conditions sufficient for crosslinking at least a portion of the multiblock copolymer further comprise a dosage of gamma radiation in a range from 0.5 Mrad (5 kGy) to 10 Mrad (100 kGy).

### EXAMPLES

The following Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### General Considerations

Polymer synthesis and reagent purifications were conducted in a glovebox (obtained under the trade designation “MBRAUN LABMASTER SP” from MBraun Inc., Stratham, N.H.). Standard air-free techniques were used for anionic polymerization and reagent manipulations. Reagents and corresponding suppliers are listed in Table 1, below.

TABLE 1

| Abbreviation | CAS#/ | Product Code | Description |
|---|---|---|---|
| Isoprene | 78-79-5 | L14619 | Monomer obtained from Alfa Aesar, Ward |
| | | | Hill, MA |
| Styrene | 100-42-5 | S4972 | Monomer (reagent plus grade, >99%) |
| | | | obtained from Sigma-Aldrich Co. LLC, St. |
| | | | Louis, MO |
| 4-Vinylpyridine | 100-43-6 | V3204 | Monomer obtained from Sigma-Aldrich Co. |
| | | | LLC |
| Benzene | 71-43-2 | BX0212-6 | Solvent obtained under the trade designation |
| | | | “OMNISOLV” from EMD Millipore |
| | | | Corporation, Billerica, MA |
| Tetrahydrofuran (THF) | 109-99-9 | 401757 | Solvent (anhydrous, ≥99.9% inhibitor-free) |
| | | | obtained from Sigma-Aldrich Co. LLC |
| 1,4-dioxane | 123-91-1 | 123-91-1 | Solvent obtained from Sigma-Aldrich Co. |
| | | | LLC |
| Sec-BuLi | 598-30-1 | 718-01 | 12 wt. % sec-butyllithium in cyclohexane; |
| | | | obtained from FMC Lithium, Charlotte, NC |
| Dibutyl-magnesium | 1191-47-5 | 345113 | 1.0M di-n-butylmagnesium solution |
| | | | in heptane obtained from Sigma Aldrich Co. |
| | | | LLC |
| Methanol | 67-56-1 | MX0480-6 | Solvent obtained under the trade designation |
| | | | “OMNISOLV” from EMD Millipore |
| | | | Corporation |
| Diphenylethylene | 530-48-3 | A14434 | 1,1-Diphenylethylene, 98% obtained from |
| | | | Alfa Aesar |
| Diglyme | 111-96-6 | 4829 | Diethylene glycol dimethyl ether solvent |
| | | | obtained from GFS Chemicals, Columbus, |
| | | | OH |

### Reagent Drying

Benzene was degassed by bubbling with argon (Ar) for longer than one hour before being cannula-transferred to a Strauss flask containing degassed 1,1-diphenylethylene. Sec-BuLi was then added under Ar counterflow via syringe, causing a very gradual color change from light yellow to deep, wine red over the course of an hour. After stirring overnight, benzene was vacuum transferred to an addition funnel. THF was similarly dried. 4-vinylpyridine was dried over CaH₂ for a minimum of 48 hours, degassed with three freeze-pump-thaw cycles, and vacuum-transferred into a sealable receiving flask containing fresh CaH₂. After an additional 24 hours over CaH₂, 4-vinylpyridine was vacuum transferred into an addition funnel. Styrene was stirred over CaH₂ overnight, degassed with three freeze-pump-thaw cycles, and then vacuum-transferred into a Schlenk bomb containing dried dibutyl-magnesium. After stirring overnight in an Ar atmosphere, styrene was again vacuum-transferred into a receiving flask to afford a final, dry monomer. Isoprene was dried as detailed above with sequential vacuum transfers from CaH₂ and dibutyl-magnesium. Diphenylethylene was degassed with three freeze-pump-thaw cycles and distilled off of a sub-stoichiometric amount of sec-BuLi (about 2.5 mL 1.4 M sec-BuLi for 60 mL diphenylethylene). All other chemicals were used as received.

### Gel Permeation Chromatography (GPC)

The GPC equipment included a quaternary pump, autosampler, column compartment and diode array detector (obtained under the trade designation “AGILENT 1100” from Agilent Technologies, Santa Clara, Calif.) operated at a flow rate of 1.0 mL/min. The GPC column set (obtained under the trade designation “STYRAGEL HR 5E” (300 mm length x 7.8 mm internal diameter) from Waters Corporation, Milford, Mass.) plus a guard column (obtained under the trade designation “STYRAGEL GUARD COLUMN” from Waters Corporation, Milford, Mass.). The detection consisted of a light scattering detector (obtained under the trade designation “DAWN HELEOS II 18 ANGLE LIGHT SCATTERING DETECTOR” from Wyatt Technology Corporation, Santa Barbara, Calif.), and a differential refractive index detector (obtained under the trade designation “OPTILAB T-REX” from Wyatt Technology Corporation). Data were collected and analyzed using software obtained under the trade designation “ASTRA” (Version 6) from Wyatt Technology Corporation. The column compartment, viscometer and differential refractive index detector were set to 40° C.

### Nuclear Magnetic Resonance (NMR)

¹H NMR spectra were recorded on a spectrometer (obtained under the trade designation “BRUKER AVANCE III 500 MHz NMR” from Bruker Corporation, Billerica, Mass.) and calibrated with reference to solvent resonance (residual CHCl₃ in CDCl₃, 7.24 ppm).

### Measurement of the Glass Transition Temperature by Differential Scanning Calorimetry (DSC)

The glass transition temperature, T_{g}, of the constituent blocks of a series of block copolymers was measured by differential scanning calorimetry (DSC) (obtained under the trade designation “TA INSTRUMENTS Q2000” from TA Instrument, New Castle, Del.). Block copolymer powder was loaded into DSC pans and subjected to the following thermal treatment: equilibrate at 40° C., heat at 10° C./min. to 180° C. or 200° C., cool at 5° C./min. or 10° C./min. to −85° C., heat to 200° C. at 10° C./min. The T_{g} was determined as the inflection point in the heat flow curve at the step change in heat flow that accompanies the glass transition.

### Preparation of Poly[isoprene-styrene-(4-vinylpyridine)] (IS4V)

As a representative example for polymer Sample ID 1, in a glovebox, benzene (107.2 g, 123 mL) was added to a three-neck 500 mL flask (necks: two 24/40 ground glass female and one polytetrafluoroethylene-coated valve to hose barb). The reactor was then fitted with addition funnels containing styrene and isoprene. Sec-BuLi (0.08 mL, 1.4 M I n hexanes, 0.112 mmol) was then injected into the added benzene by removing the polytetrafluoroethylene-coated valve stem. The reactor was then sealed and isoprene (4.16 g, 61.1 mmol) was introduced through the addition funnel while stirring vigorously. The color of the reaction changed slightly to very pale yellow. The polymerization was allowed to proceed for 24 hours at room temperature.

After 24 hours, styrene (11.07 g, 106.4 mmol) was introduced through the attached addition funnel. The color of the polymerization rapidly changed color to orange. The polymerization was stirred at room temperature in the glovebox for an additional 48 hours. Once styrene had completely polymerized, diphenylethylene (0.080 mL, 0.45 mmol) was added via syringe by removing the isoprene and styrene addition funnels. The color of the polymerization gradually changed color to vivid cherry red. THF and 4-vinylpyridine (a solution of 4-vinylpyridine in THF, about 8 wt. %) addition funnels were then attached to the reactor. The reactor was sealed and brought out of the glovebox before being attached to a Schlenk line by means of a hose through the hose barb. Once out of the glovebox, the addition funnel containing a THF solution of 4-vinylpyridine was cooled with a foil sleeve filled with dry ice powder.

Benzene was removed under reduced pressure to afford a dark red gum. Once benzene was removed, THF (220.2 g, 248 mL) was introduced through the attached addition funnel. Polymer was then completely redissolved before the reactor was placed in an ice bath and cooled to −78° C. with dry ice/acetone. Once cooled, 4-vinylpyridine (4.22 g vinylpyridine, 40.3 mmol) was added while stirring vigorously. The color of the reaction remained cherry-red. After 1 hour, the polymerization was terminated by addition of degassed methanol through the polytetrafluoroethylene-coated valve.

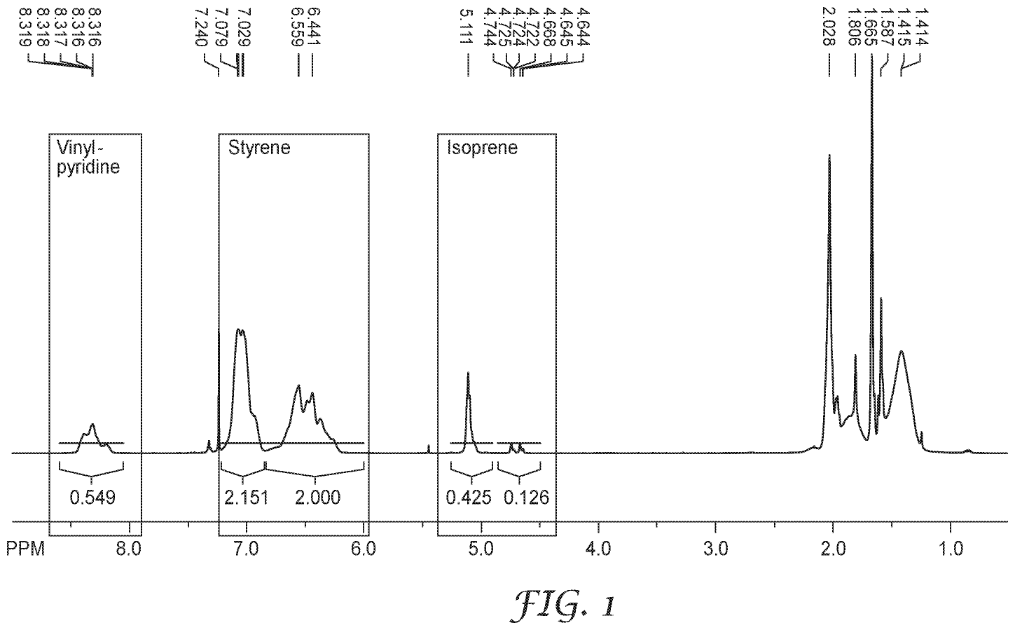

Polymer was isolated by precipitation from THF in water two times. A white solid resulted. NMR and GPC data were collected and are summarized in FIG. 1 and Table 2, below.

TABLE 2

| | % PI, | % PS, | % 4VP, | M_{w}, | Mₙ, | |
|---|---|---|---|---|---|---|
| Sample ID | mass | mass | mass | kg/mol | kg/mol | Ð |
| 1 | 17.9 | 65.5 | 15.6 | 99.4 | 95.7 | 1.04 |
| 2 | 20.9 | 61.6 | 17.5 | 94.3 | 90.2 | 1.05 |

### Membrane Formation

Casting solutions of IS4V were prepared by dissolving 12 wt. % dry polymer powder in a binary solvent comprising 1,4-dioxane and THF (70/30 w/w). The IS4V solutions were transparent and macroscopically homogeneous.

Samples used for dissolution runs (described below) after radiation treatment were cast by hand. The casting solutions were cast as a thin flat sheet using a notch bar coater with an 8 mil to 11 mil (203.2 micrometers to 279 micrometers) gap height onto a dense carrier film of corona-treated biaxially-oriented polypropylene (BOPP). Immediately after casting, the coatings were allowed to sit for a defined amount of time (75 or 90 seconds) in air prior to immersion in a room temperature water coagulation bath. Samples were left in the coagulation bath for at least 30 minutes before being washing in fresh water.

Samples used for tensile strain-to-break and molecular weight cutoff (MWCO) runs were formed on a custom-built roll-to-roll coating apparatus. The casting solution was dispensed by a syringe pump at a rate of 3.5 mL/min onto a corona-treated BOPP dense carrier film and spread using a notch bar coater with an 8 to 11 mil (203.2 micrometers to 279 micrometers) gap height. A line speed of 0.4 meter per minute (1.33 feet per minute) resulted in a 33 second evaporation time prior to immersion of the wet film into a deionized water precipitation bath. The wet film turned white and opaque within a few seconds of immersion in the primary precipitation bath. After passing through the coagulation bath, the film was passed through a secondary wash bath of water.

### Dissolution Runs

For e-beam irradiation, IS4V membranes were placed in sealable plastic bags, which were taped to a polyester carrier web. Samples were conveyed through an electron beam (obtained under the trade designation “CB-300” from Electro Sciences Inc., Wilmington, Mass.) at 24.1 feet per minute and subjected to e-beam doses of 5 (50), 10 (100), 15 (150), 20 (200), 40 (400) Mrad (kGy) at an accelerating voltage of 240 keV. For UV runs, a polyethylene terephthalate (PET) carrier web was threaded through the entrance and exit slits of an insertable cure chamber which housed low pressure VUV lamps (obtained from Heraeus, Hanau, Germany) oriented at 90° relative to the web path. The chamber was purged with nitrogen gas to an oxygen level of less than 50 ppm. A sample was affixed to the PET web and conveyed through the chamber. Thereby exposing the sample to the energy (15-300 mJ/cm²), measured with a UV power meter (obtained from Hamamatsu, Hamamatsu City, Japan) using a detector head (obtained under the trade designation “H-9535” from Hamamatsu). Samples were subjected to UV doses of 15, 65, 145, and 300 mJ/cm².

Membrane discs with a diameter of 44 mm were immersed at room temperature in at least 10 mL of THF. As shown in Table 3, below, control samples not subjected to radiation treatment fully dissolved in less than 1 second after immersion in THF, resulting in a transparent, homogeneous solution. In contrast, all samples subject to either e-beam or UV treatment were not fully soluble in THF. At the lower end of radiation dose, discrete insoluble gels were observed; at the higher end of radiation dose, the membrane discs remained integral, but became translucent. FIG. 2 is a photograph comparing the result of dissolving a control (no e-beam) membrane to that of a sample subjected to a 40 Mrad (400 kGy) e-beam treatment. The control sample is on the left. The sample on the right received a 40 Mrad (400 kGy) e-beam dose.

TABLE 3

| | Insoluble Fraction | |
|---|---|---|
| Radiation treatment | Observed? | Comments |
| No treatment | No | Membrane dissolved in <1 |
| | | second |
| E-beam doses from 5-40 | Yes, all doses | Insoluble fraction increased |
| Mrad (50-400 kGy) | | with increasing dose |
| UV doses from 15-300 | Yes, all doses | Insoluble fraction increased |
| mJ/cm² | | with increasing dose |

### Chemical Crosslinking

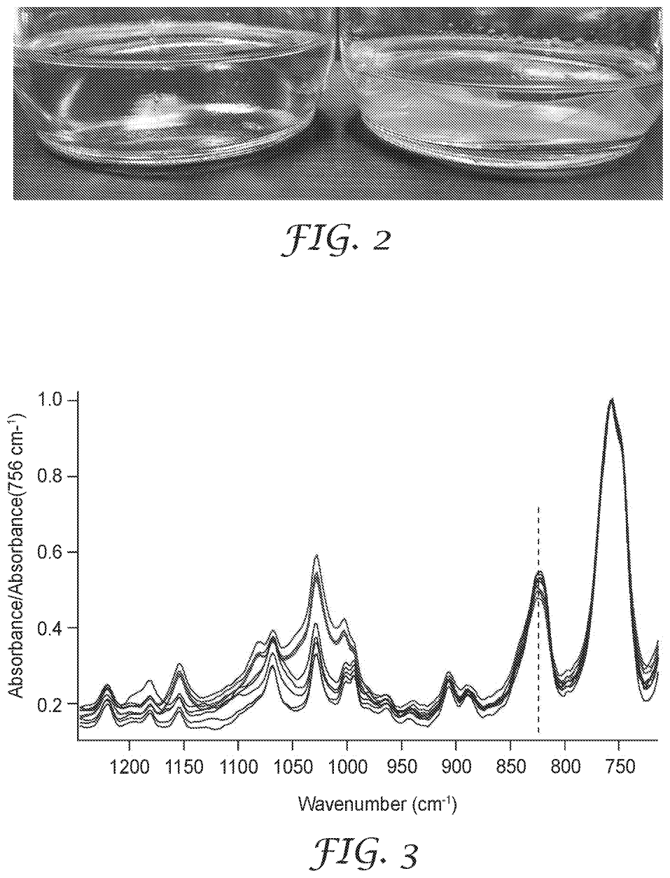

Fourier transform infrared attenuated total reflectance (FTIR-ATR) spectroscopy was used to probe for spectroscopic evidence of chemical crosslinking in IS4V membranes. Spectral data was obtained with an FTIR spectrometer (obtained under the trade designation “NICOLET 6700 SERIES FTIR SPECTROMETER” from Thermo Scientific, Waltham, Mass.) using a deuterated L-alanine doped triglycine sulfate (DLaTGS) detector at 4 cm-1 resolution and a single-reflection ATR accessory (obtained under the trade designation “PIKE SMARTMIRACLE” from Pike Technologies, Madison, Wis.) with a germanium crystal. Each spectrum was acquired with 32 scans and a spectral range of 4000-650 cm⁻¹. FIG. 3 shows FTIR-ATR spectra for a control (no e-beam) membrane, and an IS4V membrane that received a 10 Mrad (100 kGy) e-beam dose at 300 keV.

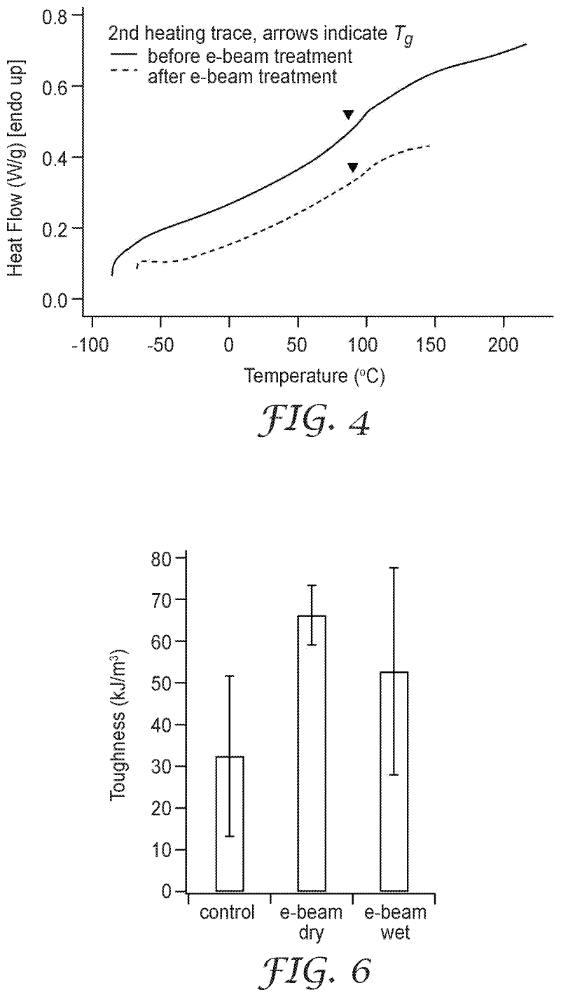

Differential scanning calorimetry (DSC) runs were conducted using a differential scanning calorimeter (obtained under the trade designation “Q2000” from TA Instruments, New Castle, Del.). Samples were loaded in a hermetic aluminum pan (obtained under the trade designation “TA HERMETIC” from TA Instruments), equilibrated at 40° C., and heated to the maximum temperature (220° C. and 150° C. for the pre- and post-radiation treatment samples, respectively) at a rate of 10° C./min. After annealing at the maximum temperature for 1 minute, samples were cooled at a rate of 10° C./min to the minimum temperature (−90° C. and −70° C. for the pre- and post-radiation treatment samples, respectively). Samples were not aged at the minimum temperature, but were immediately heated to the maximum temperature at a rate of 10° C./min. Thermal traces upon this second heating are shown in FIG. 4A peak in the first derivative of heat flow versus temperature was used to identify glass transitions.

### Tensile Strain-to-Break Runs

Samples used for tensile strain-to-break runs were subjected to an e-beam dose of 10 Mrad (100 kGy) at an accelerating voltage of 300 keV in both the wet and dry state. For both wet and dry sample sets, control samples—which did not receive an e-beam treatment—experienced identical drying history as samples that received an e-beam treatment. For both wet and dry e-beam runs, samples were placed in sealable plastic bags, which were taped to a carrier web to pass through the e-beam.

Tensile strain-to-break runs were conducted on a tensile tester (obtained under the trade designation “INSTRON 5544” from Instron, Canton, Mass.) with a 5-newton load cell. Samples were cut into tensile bars with initial cross-sectional dimensions of 6.5 mm wide x 0.046 mm thick. The initial gauge length was 25.4 mm, and samples were stretched at a rate of 1 mm/min. All samples were immersed in water prior to testing. Samples were removed from the water bath immediately before testing, and testing was conducted at ambient conditions with tests typically lasting less than 60 seconds.

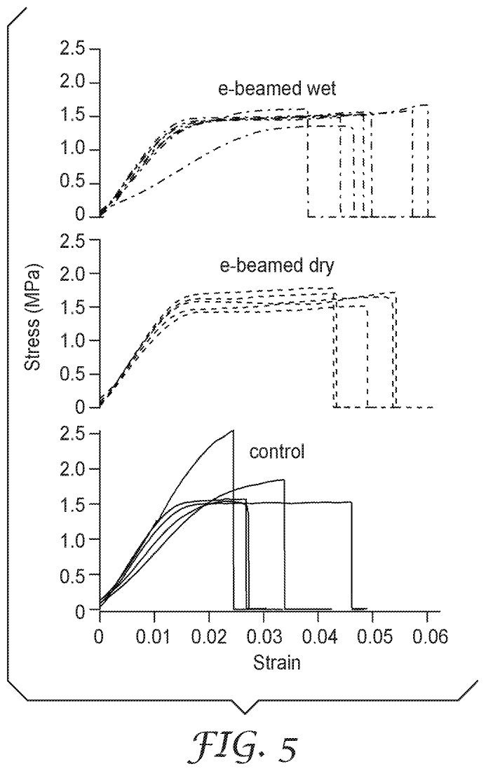

Raw tensile data (i.e., force versus strain) were converted to units of stress using the initial cross-sectional area of 6.5×0.046 mm. The data were then shifted to account for slack introduced when mounting the sample by applying an algorithm that finds the maximum value of force, then starts at the beginning of the curve and finds where the value is 2% of the maximum value; this x-value becomes the new zero strain point. FIG. 5 shows the stress-strain response of IS4V membranes.

Toughness was calculated by integrating the stress-strain curves over the strain range from 0 to 0.1. FIG. 6 and Table 4, below, summarize toughness for IS4V control membranes and membranes e-beam treated in the wet and dry state.

TABLE 4

| | Toughness ± 1 standard | Number of |
|---|---|---|
| Sample | deviation, kJ/m³ | Replicate Sample |
| Control | 32 ± 19 | 6 |
| E-beamed Wet | 66 ± 7 | 5 |
| E-beamed Dry | 53 ± 25 | 8 |

### Molecular Weight Cutoff

Molecular weight cutoff (MWCO) runs were conducted to measure the retention performance of IS4V membranes. Membrane discs with a diameter of 44 mm were loaded in a stirred cell (obtained under the trade designation “AMICON STIRRED CELL MODEL 8050” from EMD Millipore Corporation), using a PES microfiltration membrane (obtained under the trade designation “MICROPES 2F” from 3M Germany, Wuppertal, Germany) as a mechanical support layer underneath the IS4V membrane. The PES membrane does not significantly impact flow rate or retention in the tests described below.

Membranes were flushed with at least 20 mL of water at 1.38 bar (20 psi) applied pressure. Pressure integrity of the membrane in the stirred cell was then verified by emptying all standing water from the cell, applying 1.38 bar (20 psi) pressure to the wetted membrane, and placing the outlet tube in a beaker of water. The stirred cell seal was considered acceptable if less than one bubble was observed exiting the outlet tube in 30 seconds. Next, the stirred cell was loaded with 50 mL of a 0.1 wt. % challenge solution of 275 kg/mol poly(ethylene oxide) (PEO) (obtained from Polymer Source, Inc., Montreal, Canada) in water. The stirred cell was then pressured to 10 psi while stirring at 400 rpm. The first 1 mL of permeate was discarded; the next 2 mL were collected for further analysis.

A total organic carbon analyzer (obtained under the trade designation “SHIMADZU TOC-L” from Shimadzu Scientific Instruments, Columbia, Md.) was used to determine the concentration of PEO, C_{PEO}, in the challenge and permeate solutions. Retention, R, was calculated as R=100×(1−C_{PEO,permeate}/C_{PEO,challenge}). Table 5, below, summarizes PEO retention data.

TABLE 5

| | | Retention of | |
|---|---|---|---|
| Sample | Replicate | 275 kg/mol PEO, % | Comments |
| Control for wet | 1 | 93.6 | |
| e-beam | 2 | 91.4 | |
| | 3 | 90.5 | |
| E-beamed wet | 1 | n/a | disc fractured |
| | 2 | 92.0 | |
| | 3 | 88.0 | |
| Control for dry | 1 | n/a | disc fractured |
| e-beam | 2 | 88.5 | |
| | 3 | 95.1 | |
| E-beamed dry | 1 | n/a | disc fractured |
| | 2 | 92.6 | |
| | 3 | n/a | disc fractured |

### Solvent Resistance

An IS4V control membrane not subjected to an e-beam treatment was loaded into a stirred cell and flushed with a sanitizing solution of ethanol/water (70 weight percent/30 weight percent). Several milliliters of solution were flushed through the membrane, after which the membrane was found to have fractured in several locations, thus compromising the retention integrity of the membrane. Next, an IS4V membrane treated with a 10 Mrad (100 kGy) e-beam dose at 300 keV was loaded into a stirred cell and flushed with the water/ethanol sanitizing solution. After exposure to the water/ethanol solution, the ethanol/water solution was replaced with a PEO challenge solution, and a MWCO run identical to that described above was conducted. The e-beam treated disc exhibited a retention of 77% for 275 kg/mol PEO.

### Gel Fraction

IS4V copolymer was synthesized as described in the “Preparation of Poly[isoprene-styrene-(4-vinylpyridine)] (IS4V)” above. IS4V powder was dissolved in a ternary solvent system comprising 8 wt. % diglyme, 32 wt. % dioxane, and 60 wt. % THF at a solids concentration of 10 wt. %. After complete dissolution, the polymer solution was cast into a thin film onto a plastic carrier film using a notch bar coater with a gap height of 10 mil (254 micrometers). A portion of the solvent system evaporated from the wet film over a period of 60 seconds. The wet polymer film was then immersed in a water precipitation bath, forming a white, opaque film that delaminated from the carrier film. The polymer membrane was dried and weighed.

For the e-beam treatment, IS4V membranes were placed in plastic bags and e-beam treated at doses of 5, 10, and 20 Mrad (50, 100, and 200 kGy). All conditions were run in duplicate. The membranes were removed from the bags and dissolved in THF. After complete dissolution of the control membrane, the THF solutions were filtered using a standard vacuum filtration apparatus with pre-weighed filter paper (obtained under the trade designation “05TH-100W” from Hirose Paper Mfg. Co., Ltd, Tosa, Japan) or obtained under the trade designation “WHATMAN GRADE 4 QUALITATIVE FILTER PAPER” from GE Healthcare UK Limited, Buckinghamshire, United Kingdom). Samples e-beam treated at 20 Mrad (200 kGy) fouled the Hirose filter, so Whatman filter paper was used for these samples. The mass of the filter paper plus retentate was measured after drying the THF. The gel fraction of the membrane was calculated as the mass of retentate divided by the initial dry mass of membrane and is summarized in Table 6, below.

TABLE 6

| E-beam Dose, | | Filter | Calculated Gel | |
|---|---|---|---|---|
| Mrad (kGy) | Replicate | Paper | Fraction, % | Notes |
| 0 (0) | 1 | Hirose | 1.1 | |
| (control) | 2 | | 1.2 | |
| 5 (50) | 1 | Hirose | 1.9 | |
| | 2 | | 2.0 | |
| 10 (100) | 1 | Hirose | 1.5 | |
| | 2 | | 2.1 | |
| 20 (200) | 1 | Hirose | Not | Fouled Hirose |
| | | | calculated | filter |
| | 2 | Whatman | 42 | |

### Comparative Example: E-Beam Treatment of PES Membrane

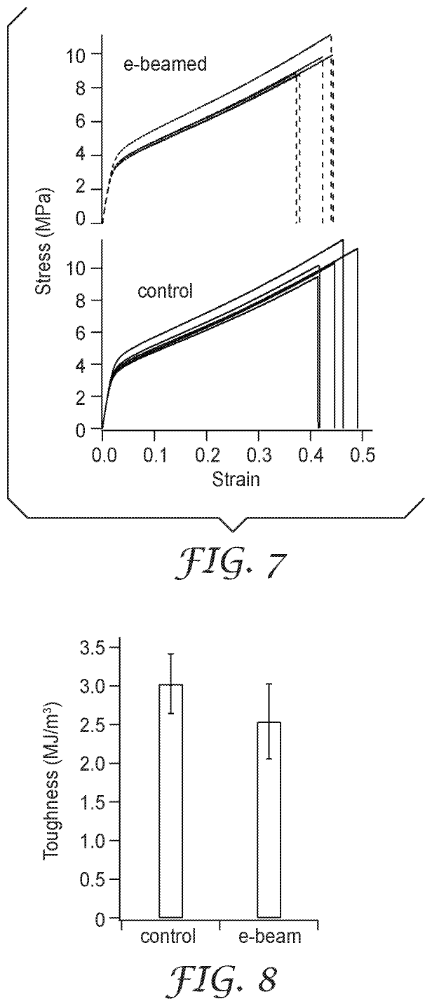

A PES phase inversion membrane (obtained under the trade designation “MICROPES 2F” from 3M Germany) was placed in a sealable plastic bag and subjected to an e-beam treatment of 10 Mrad (100 kGy) at 300 keV in the dry state. Tensile strain-to-break runs were conducted with the e-beam treated PES membranes and compared to a control membrane that did not receive an e-beam treatment. Conditions for the strain-to-break run were identical to those described above, except for the initial cross-sectional area, which was 6.5×0.105 mm. FIG. 7 shows the stress-strain response for PES membranes.

Toughness was calculated by integrating the stress-strain curves over the strain range from 0 to 1. FIG. 8 and Table 7, below, summarize the toughness of the PES membranes.

TABLE 7

| | Toughness ± 1 standard | Number of |
|---|---|---|
| Sample | deviation, MJ/m³ | Replicate Samples |
| Control | 3.0 ± 0.4 | 5 |
| E-beamed | 2.5 ± 0.5 | 5 |

### Prophetic Example: E-Beam Treatment to Minimize Pore Plugging by Hydrophilic Blocks

A membrane is made from a block copolymer containing a hydrophilic block such as poly(ethylene oxide) (PEO). The membrane is subjected to an e-beam treatment in either the dry state or a partially hydrated state, but not fully wet with water. The pure water hydraulic permeability of the e-beam treated membrane is compared to the hydraulic permeability of a control membrane which was not subjected to an e-beam treatment. The hydraulic permeability of the control membrane is found to be lower than that of the e-beam treated membrane.

Thus, various embodiments of the ISOPOROUS MEMBRANES INCLUDING CROSSLINKED MULTIBLOCK COPOLYMERS are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An isoporous membrane comprising a multiblock copolymer film,
wherein the multiblock copolymer comprises polyisoprene and a block formed from a vinyl aromatic monomer, wherein the multiblock copolymer is crosslinked, and
the film has a toughness of at least 50 kJ/m³ as a free-standing film when wet, as measured by integrating the area under a stress-strain curve for the film.

2. The isoporous membrane of claim 1, wherein the film has a toughness of at least 70 kJ/m³ as a free-standing film when wet, as measured by integrating the area under a stress-strain curve for the film.

3. The isoporous membrane of claim 1, wherein the film has a toughness of at least 80 kJ/m³ as a free-standing film when dry, as measured by integrating the area under a stress-strain curve for the film.

4. The isoporous membrane of claim 1, wherein the multiblock copolymer has a gel fraction of at least 2 weight percent.

5. The isoporous membrane of claim 1, wherein the multiblock copolymer has a crosslink density of at least 10 weight percent.

6. The isoporous membrane of claim 1, wherein the multiblock copolymer has a crosslink density of at least 40 weight percent.

7. The isoporous membrane of claim 1, wherein the pores at a surface of the membrane have a size of 1 nanometer to 500 nanometers.

8. The isoporous membrane of claim 1, wherein a standard deviation in pore diameter at a surface of the membrane is at least 4 nanometers from a mean pore diameter at the surface of the membrane when the mean surface pore diameter is in a range from 5 nanometers to 15 nanometers; the standard deviation in pore diameter at the surface of the membrane is at least 6 nanometers from the mean pore diameter at the surface of the membrane when the mean pore diameter at the surface of the membrane is in a range from 15 nanometers to 25 nanometers; and the standard deviation in pore diameter at the surface of the membrane is not greater than 25% of the mean pore diameter at the surface of the membrane when the mean pore diameter at the surface of the membrane is in a range from 25 nanometers to 50 nanometers.

9. The isoporous membrane of claim 1, wherein the multiblock copolymer is a diblock copolymer, a triblock copolymer, or a pentablock copolymer, wherein at least one block is immiscible with at least one other block.

10. The isoporous membrane of claim 1, wherein the multiblock copolymer comprises:
a rubbery block with a T_{g} of ≤25° C.; and
a hydrogen-bonding block selected from the group consisting of poly((4-vinyl)pyridine), poly((2-vinyl) pyridine), poly(ethylene oxide), poly(methacrylate), poly(methyl methacrylate), poly(dimethylethyl amino ethyl methacrylate), poly(acrylic acid), and poly(hydroxystyrene),
wherein the film has a surface layer having a thickness in a range from 20 nanometers to 500 nanometers and a plurality of pores in a range from 5 nanometers to 100 nanometers in size and a pore density of at least 1×10¹⁴ pores/m²; and wherein the film has a bulk layer having a thickness in range from 5 micrometers to 500 micrometers, pores having a size in a range from 10 nanometers to 100 micrometers, and an asymmetric substructure

11. The isoporous membrane of claim 1, wherein the multiblock copolymer film is a graded film.

12. A method of making an isoporous membrane of claim 1, the method comprising:
providing an isoporous membrane comprising a non-crosslinked multiblock copolymer film, wherein the multiblock copolymer comprises polyisoprene and a block formed from a vinyl aromatic monomer, wherein the film has a toughness of at most 49 kJ/m³ as a free-standing film when wet, as measured by integrating the area under a stress-strain curve for the film; and
exposing the isoporous membrane to conditions sufficient for crosslinking at least a portion of the multiblock copolymer.

13. The method of claim 12, wherein conditions sufficient for crosslinking at least a portion of the multiblock copolymer comprise irradiation by actinic radiation.

14. The method of claim 13, wherein conditions sufficient for crosslinking at least a portion of the multiblock copolymer comprise irradiation by ultraviolet (UV) energy.

15. The method of claim 14, wherein conditions sufficient for crosslinking at least a portion of the multiblock copolymer further comprise a dosage of UV energy in a range from 15 mJ/cm² to 300 mJ/cm².

16. The method of claim 13, wherein conditions sufficient for crosslinking at least a portion of the multiblock copolymer comprise exposure to e-beam radiation.

17. The method of claim 16, wherein conditions sufficient for crosslinking at least a portion of the multiblock copolymer further comprise a dosage of e-beam radiation in a range from 0.2 Mrad (2 kGy) to 20 Mrad (200 kGy) and a residence time of the isoporous membrane in the e-beam radiation in a range from 1 second to 5 seconds.

18. The method of claim 13, wherein conditions sufficient for crosslinking at least a portion of the multiblock copolymer comprise irradiation by gamma radiation.

19. The method of claim 18, wherein conditions sufficient for crosslinking at least a portion of the multiblock copolymer further comprise a dosage of gamma radiation in a range from 0.5 Mrad (5 kGy) to 10 Mrad (100 kGy).
